(19) United States
(12) Patent Application Publication
(10) Pub. No.: US 2023/0295822 A1
(43) Pub. Date: Sep. 21, 2023

(54) METHOD OF CONTROLLING LOAD OF WATER ELECTROLYSIS STACK, METHOD OF PRODUCING HYDROGEN, AND WATER ELECTROLYSIS APPARATUS

(71) Applicant: TOYOTA JIDOSHA KABUSHIKI KAISHA, Toyota-shi (JP)

(72) Inventors: Keisuke FUJITA, Toyota-shi (JP); Tsuyoshi HAMAGUCHI, Nagakute-shi (JP); Ryuichi IWATA, Nagakute-shi (JP); Tomoyuki KAYAMA, Nagakute-shi (JP); Takahiro IKEDA, Nagakute-shi (JP)

(73) Assignee: TOYOTA JIDOSHA KABUSHIKI KAISHA, Toyota-shi (JP)

(21) Appl. No.: 18/166,014

(22) Filed: Feb. 8, 2023

(30) Foreign Application Priority Data
Mar. 18, 2022 (JP) 2022-043786

(51) Int. Cl. C25B 15/025; C25B 9/77; C25B 9/23; C25B 1/04; C25B 15/027; C25B 15/033

(52) U.S. Cl. CPC C25B 15/025; C25B 1/04; C25B 9/23; C25B 9/77; C25B 15/027; C25B 15/033

(57) ABSTRACT

Provided is a method of controlling a load of a water electrolysis stack in which a plurality of water electrolysis cells including an anode disposed on one side and a cathode disposed on the other side with a solid polyelectrolyte film interposed are stacked and housed. The method includes determining an appropriate load based on a condition of an inside of the water electrolysis stack obtained from at least one of a temperature of the inside of the water electrolysis stack, an electrical resistance, or a water flow rate, and changing application of the load on the water electrolysis stack such that the load is the appropriate load.

### CROSS-REFERENCE TO RELATED APPLICATION

This application claims priority to Japanese Patent Application No. 2022-043786 filed on Mar. 18, 2022, incorporated herein by reference in its entirety.

### BACKGROUND

### 1. Technical Field

The present disclosure relates to a method of controlling a load of a water electrolysis stack, a method of producing hydrogen and a water electrolysis apparatus.

### 2. Description of Related Art

Japanese Unexamined Patent Application Publication No. 2003-147562 (JP 2003-147562 A) discloses a structure of a stack fastened with a plurality of screw shafts, in which each load meter or each strain gauge is provided on each of the screw shafts in order to equalize axial forces of screws.

### SUMMARY

However, in the related art, load management is solely in the initial state, and load management cannot be performed in accordance with environmental conditions, operating conditions, and deterioration over time. This may cause leaks and early deterioration. For example, in a case where the load is insufficient, leaks may occur due to deterioration in sealing performance, or a degree of adhesion between layers constituting the water electrolysis cells may decrease. As a result, performance of water electrolysis may deteriorate. On the other hand, in a case where the load is excessively large, the layers of the water electrolysis cells will be burdened and may be damaged, and this situation leads to early deterioration.

The present disclosure provides a method of controlling a load of a water electrolysis stack capable of performing more appropriate load management and maintenance of performance. In addition, the present disclosure provides a method of producing hydrogen and a water electrolysis apparatus capable of performing more appropriate load control and maintenance of performance.

A first aspect of the present disclosure relates to a method of controlling a load of a water electrolysis stack in which a plurality of water electrolysis cells including an anode disposed on one side and a cathode disposed on the other side with a solid polyelectrolyte film interposed are stacked and housed. The method includes determining an appropriate load based on a condition of an inside of the water electrolysis stack obtained from at least one of a temperature of the inside of the water electrolysis stack, an electrical resistance, and a water flow rate, and changing application of the load on the water electrolysis stack such that the load is the appropriate load.

A second aspect of the present disclosure relates to a method of producing hydrogen. The method includes performing normal hydrogen production by the water electrolysis cells, and performing hydrogen production by periodically performing load control by the method of controlling the load of the water electrolysis stack.

A third aspect of the present disclosure relates to a water electrolysis apparatus including a water electrolysis stack in which a plurality of water electrolysis cells including an anode disposed on one side and a cathode disposed on the other side with a solid polyelectrolyte film interposed are stacked and housed. The water electrolysis apparatus includes a pressurizer that is provided in the water electrolysis stack and is configured to apply a load to the water electrolysis cells by pressing the water electrolysis stack, at least one sensor of a sensor that is configured to measure a temperature of an inside of the water electrolysis stack, a sensor that is configured to measure an electrical resistance, and a sensor that is configured to measure a water flow rate, and a controller that is configured to receive signals from the pressurizer and the at least one sensor and is connected to transmit a signal to the pressurizer. The controller is configured to determine an appropriate load based on a condition of the inside of the water electrolysis stack obtained from at least one of the temperature of the inside of the water electrolysis stack, the electrical resistance, and the water flow rate measured by the at least one sensor, and instruct the pressurizer to change application of the load on the water electrolysis stack such that the load is the appropriate load.

According to the aspects of the present disclosure, it is possible to more appropriately perform load management of the water electrolysis cells and the water electrolysis stack to maintain the performance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a configuration of a water electrolysis apparatus;

FIG. 2 is a conceptual diagram showing a configuration of a water electrolysis cell;

FIG. 3 is a conceptual diagram showing a configuration of a water electrolysis stack;

FIG. 4 is a conceptual diagram of a computer (controller);

FIG. 5 is a flowchart showing a flow of a method of controlling a load of the water electrolysis stack; and

FIG. 6 is another flowchart showing a flow of a method of controlling a load of the water electrolysis stack.

### DETAILED DESCRIPTION OF EMBODIMENTS

### 1. Water Electrolysis Apparatus

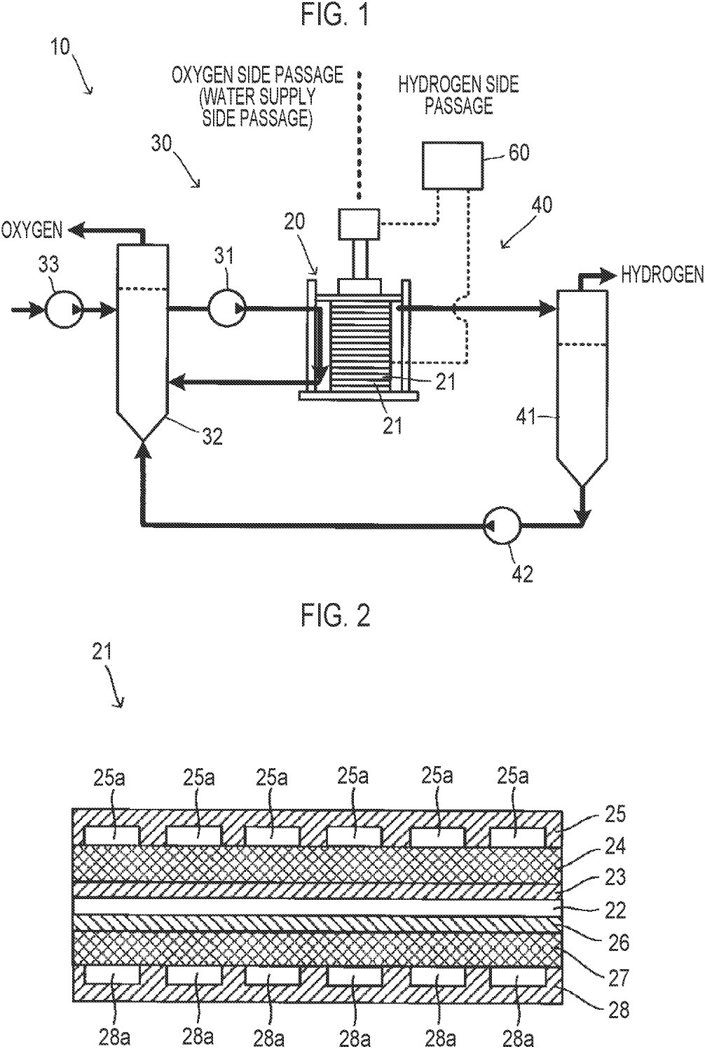

FIG. 1 conceptually shows a water electrolysis apparatus 10 according to an embodiment. The water electrolysis apparatus 10 in the present embodiment has a water electrolysis stack 20, an oxygen side passage 30, a hydrogen side passage 40 and a controller 60. In the water electrolysis apparatus 10, purified water is supplied from the oxygen side passage 30 to water electrolysis cells 21 provided in the water electrolysis stack 20 and is decomposed into hydrogen and oxygen by applying electric current to the purified water. Thereby, the hydrogen is obtained, and is separated from the oxygen through the hydrogen side passage 40.

### 1.1. Oxygen Side Passage (Water Supply Side Passage)

The oxygen side passage (water supply side passage) 30 is a passage that includes a pipe configured to obtain oxygen by supplying the purified water to the water electrolysis stack 20. The purified water is supplied to the water electrolysis stack 20 by a pump 31 in the oxygen side passage 30, and the generated oxygen and unused water are discharged from the water electrolysis stack 20 and supplied to the gas liquid separator 32. The gas liquid separator 32 separates oxygen from the purified water. The separated oxygen is discharged, and the purified water is supplied to the pump 31 again. The deficient purified water is supplied from the pump 33 to the gas liquid separator 32. The pipe connects the devices described above to each other.

### 1.2. Hydrogen Side Passage

The hydrogen side passage 40 is a passage that includes a pipe configured to extract hydrogen separated in the water electrolysis stack 20. The hydrogen and water (purified water) discharged from the water electrolysis stack 20 are supplied to the gas liquid separator 41 through the hydrogen side passage 40. The gas liquid separator 41 separates the hydrogen from the water. The separated hydrogen is collected, and the water is sent through the pump 42 to the gas liquid separator 32 in the oxygen side passage 30 and is reused. The pipe connects the devices described above to each other.

### 1.3. Water Electrolysis Cell

The water electrolysis cell 21 is a unit element configured to decompose the purified water into hydrogen and oxygen, and a plurality of water electrolysis cells 21 are stacked and disposed in the water electrolysis stack 20. FIG. 2 conceptually shows a form of the water electrolysis cell 21.

The water electrolysis cell 21 is formed of a plurality of layers. One of the layers serves as an oxygen generation electrode (anode) and the other thereof serves as a hydrogen generation electrode (cathode) with a solid polyelectrolyte film 22 interposed therebetween. The anode has an anode catalyst layer 23, an anode gas diffusion layer 24, and an anode separator 25 which are stacked in this order from the solid polyelectrolyte film 22 side. On the other hand, the cathode has a cathode catalyst layer 26, a cathode gas diffusion layer 27, and a cathode separator 28 in this order from the solid polyelectrolyte film 22 side. Here, a water electrolysis film electrode assembly means a stacked body of the solid polyelectrolyte film 22, the anode catalyst layer 23 disposed on the anode side of the solid polyelectrolyte film 22, and the cathode catalyst layers 26 disposed on the cathode side of the solid polyelectrolyte film 22. A thickness of the water electrolysis film electrode assembly is typically about 0.4 mm, and a thickness of the water electrolysis cell 21 is typically about 1.3 mm. For example, each layer is as follows.

### 1.3.1. Solid Polyelectrolyte Film

The solid polyelectrolyte film 22 is an aspect of a film having proton conductivity. The material (electrolyte) constituting the solid polyelectrolyte film 22 in the present embodiment is a solid polymer material, and examples thereof include a proton-conducting ion-exchange film made of a fluorine-based resin, a hydrocarbon-based resin material, or the like. The proton-conducting ion-exchange film exhibits favorable proton conductivity (electrical conductivity) in wet conditions. A more specific example of the film is a film made of Nafion (registered trademark), which is a perfluoro-based electrolyte. Although a thickness of the solid polyelectrolyte film 22 is not particularly limited, the thickness is 200 µm or less, preferably 100 µm or less, and more preferably 30 µm or less.

### 1.3.2. Anode Catalyst Layer

The anode catalyst layer (oxygen electrode catalyst layer) 23 is a layer having a catalyst including at least one of noble metal catalysts, such as Pt, Ru, and Ir and oxides thereof. More specifically, examples of the catalyst include Pt, iridium oxide, ruthenium oxide, iridium ruthenium oxide, or mixtures thereof. Examples of the iridium oxide include iridium oxide (IrO₂, IrO₃), iridium tin oxide, and iridium zirconium oxide. Examples of the ruthenium oxide include ruthenium oxide (RuO₂, Ru₂O₃), ruthenium tantalum oxide, ruthenium zirconium oxide, ruthenium titanium oxide, and ruthenium titanium cerium oxide. Examples of the iridium ruthenium oxide include iridium ruthenium cobalt oxide, iridium ruthenium tin oxide, iridium ruthenium iron oxide, and iridium ruthenium nickel oxide.

### 1.3.3. Anode Gas Diffusion Layer

The anode gas diffusion layer 24 is able to use a known material, and is formed of a member having gas permeability and electrical conductivity. Specific examples of the member include porous conductive members made of sintered bodies, such as metal fibers (for example, titanium fibers) or metal particles (titanium particles).

### 1.3.4. Anode Separator

The anode separator 25 is a member provided with flow passages 25a through which the purified water is supplied to the anode gas diffusion layer 24 and the oxygen generated by water decomposition flows.

### 1.3.5. Cathode Catalyst Layer

A known catalyst can be used as the catalyst included in the cathode catalyst layer 26, and examples thereof include platinum, platinum-coated titanium, platinum-supported carbon, palladium-supported carbon, cobalt glyoxime, and nickel glyoxime.

### 1.3.6. Cathode Gas Diffusion Layer

The cathode gas diffusion layer 27 is able to use a known material, and is formed of a member having gas permeability and electrical conductivity. Specific examples of the member include porous members, such as carbon cloth and carbon paper.

### 1.3.7. Cathode Separator

The cathode separator 28 is a member provided with flow passages 28a through which hydrogen generated by reduction of hydrogen ions and water accompanied with the hydrogen ions permeating the solid polyelectrolyte film 22 flow.

### 1.3.8. Generation of Hydrogen Using Water Electrolysis Cells

By using the water electrolysis cells 21 described above, hydrogen and oxygen are generated from purified water as follows. Therefore, the water electrolysis cells and water electrolysis stack according to the embodiment of the present disclosure can be provided with known members and configurations for generating hydrogen in addition to the above description. The purified water (H₂O) supplied to the anode (oxygen generation electrode) from the oxygen side passage 30 through the flow passages 25a of the anode separator 25 is decomposed into oxygen, electrons, and protons (H⁺) on the anode catalyst layer 23 to which a potential is applied by applying electric current between the anode and the cathode. In such a case, protons pass through the solid polyelectrolyte film 22 and move to the cathode catalyst layer 26. On the other hand, the electrons separated by the anode catalyst layer 23 reach the cathode catalyst layer 26 through an external circuit. Then, protons receive electrons in the cathode catalyst layer 26, and thereby hydrogen (H₂) is generated. The generated hydrogen reaches the cathode separator 28, is discharged from the flow passages 28a, and is sent to the hydrogen side passage 40. The oxygen generated in the anode catalyst layer 23 reaches the anode separator 25, is discharged from the flow passages 25a, and is sent to the oxygen side passage 30.

### 1.4. Water Electrolysis Stack

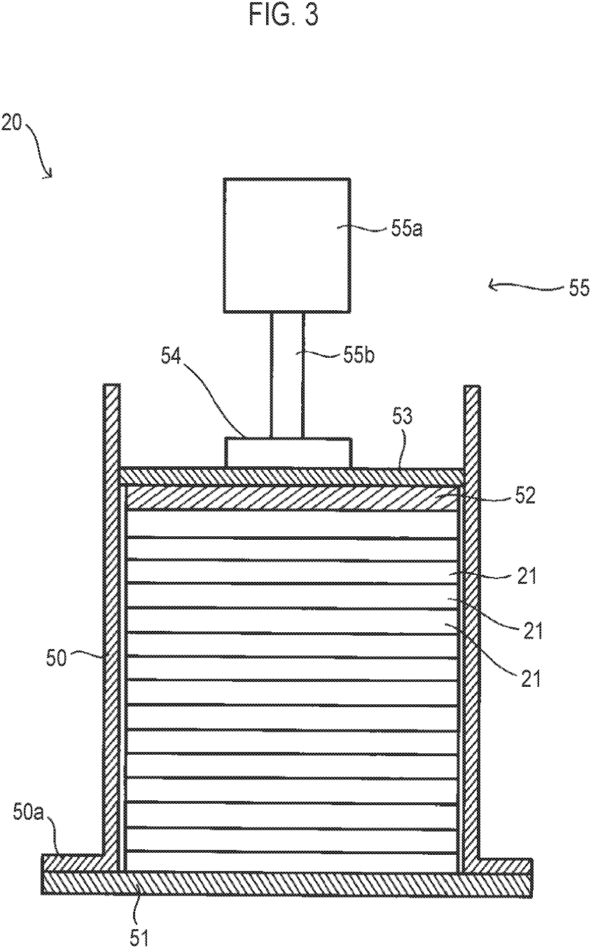

The water electrolysis stack 20 is a member formed by stacking the water electrolysis cells 21 (about 50 to 400 water electrolysis cells 21) described above, and hydrogen and oxygen are generated by applying electric current to the water electrolysis cells 21. Further, in the present embodiment, the water electrolysis stack is provided with a unit configured to control the load. FIG. 3 shows the outline of the configuration.

In the present embodiment, the water electrolysis stack 20 is provided with a stack casing 50, an end plate 51, the water electrolysis cells 21, an urging member 52, a pressing plate 53, a load cell 54, a pressurizer 55, and various sensors (not shown in the drawing). Here, the water electrolysis cells 21 are as described above.

The stack casing 50 is a housing that houses the water electrolysis cells 21 and the urging member 52 stacked together therein. In the present embodiment, the stack casing has a rectangular tubular shape with both ends opened, and a plate-like piece protrudes along the edge of one opening to the opposite side of the opening to form a flange 50a.

The end plate 51 is a plate-like member that closes an opening of the stack casing 50 on a side where the flange 50a is formed. The end plate 51 is fixed by bolts, nuts, or the like at a part overlapping the flange 50a of the stack casing 50, and is disposed to cover the stack casing 50.

The urging member 52 is housed inside the stack casing 50 together with the water electrolysis cells 21 and applies a pressing force to the stacked body of water electrolysis cells 21 in the stacking direction. As the urging member 52, for example, a disk spring or the like can be used.

The pressing plate 53 is a plate-like member that closes the opening of the stack casing 50 on the side opposite to the opening on a side where the end plate 51 is disposed. In the present embodiment, the pressing plate 53 is disposed inside the stack casing 50 and overlaps on the urging member 52, as can be seen from FIG. 3. Thereby, the pressing plate 53 is movable in the stacking direction of the water electrolysis cells 21.

The load cell 54 is a sensor that detects a load, and is configured to measure and output the load applied to the water electrolysis cells 21. As long as the load cell 54 is able to obtain the load applied to the water electrolysis cells 21, there are no particular restrictions on the type of the load cell 54 and the position of the load cell 54 to be disposed. For example, a strain gauge type load cell can be applied.

The pressurizer 55 is a device that applies a load of a pressing force to the pressing plate 53, and is configured to apply and release the pressing force. In the present embodiment, a screw shaft 55b is attached to a servomotor 55a, the screw shaft 55b is rotated by the servomotor 55a, and the screw shaft 55b moves in the direction of axis. Thereby, the load of the pressing force is applied by pressing the pressing plate 53 or is released.

Various sensors not shown in the drawing are sensors disposed in a normal water electrolysis stack. Examples of the sensors include a sensor that is configured to measure a temperature of the inside of the water electrolysis stack 20, a sensor that is configured to measure an electrical resistance of the stacked body of the water electrolysis cells 21, and a sensor that is configured to measure a flow rate of the supplied purified water.

### 1.5. Controller

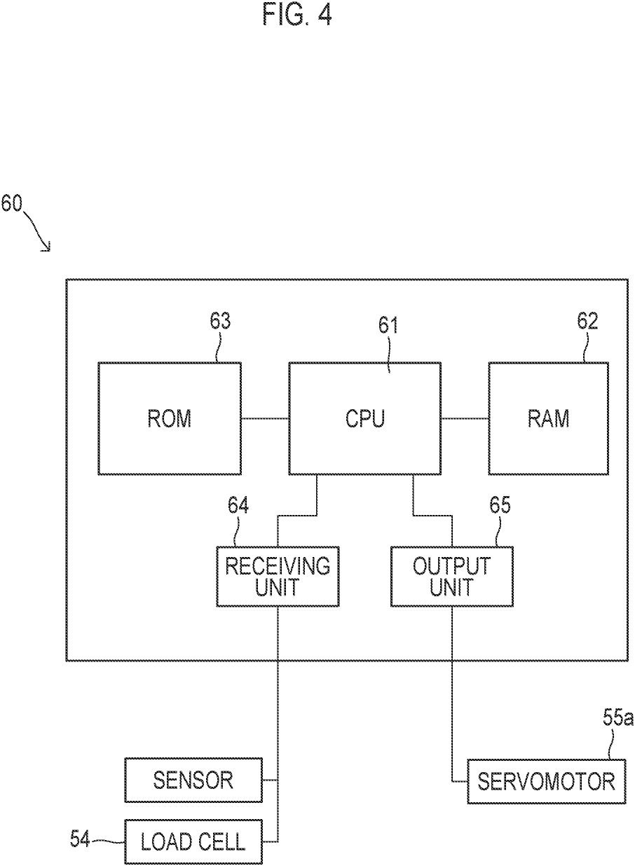

The controller 60 is a controller configured to perform the method of controlling the load of the water electrolysis stack of the present embodiment in the water electrolysis apparatus 10. Although an aspect of the controller is not particularly limited, the controller can typically be configured by a computer. In the present embodiment, the controller 60 is electrically connected to the servomotor 55a of the pressurizer 55, the load cell 54, and various sensors, and is configured to obtain the measurement results of the load cell 54 and various sensors and to instruct the servomotor 55a based thereon. FIG. 4 shows conceptually a configuration example of the computer 60 as the controller 60.

The computer 60 is provided with a central processing unit (CPU) 61 that is a processor, a random access memory (RAM) 62 that functions as a work area, a read-only memory (ROM) 63 as a storage medium, a receiving unit 64 that is an interface configured for the computer 60 to receive information regardless of wired or wireless, and an output unit 65 which is an interface configured to send information from the computer 60 to the outside regardless of wired or wireless. The load cell 54 and various sensors are electrically connected to the receiving unit 64, and are configured to receive respective values (pressure, temperature, flow rate, etc.) thereof as signals. On the other hand, the servomotor 55a is electrically connected to the output unit 65, and rotates the screw shaft 55b in response to a signal from the computer 60.

The computer 60 stores a computer program configured to execute steps of the water electrolysis stack method of controlling the load according to the embodiment of the present disclosure as specific commands. In the computer 60, the CPU 61, the RAM 62, and the ROM 63 as hardware resources cooperate with a computer program. Specifically, the CPU 61 implements a function by executing the computer program, which is recorded in the ROM 63, in the RAM 62 functioning as a work area based on the signals representing values acquired through the receiving unit 64 from the load cell 54 and various sensors. The RAM 62 stores the information acquired or generated by the CPU 61. Further, a signal for rotation is transmitted to the servomotor 55a through the output unit 65 when needed based on the steps of the method of controlling a load of the water electrolysis stack according to the embodiment of the present disclosure. The specific content of the method of controlling the load of the water electrolysis stack according to the embodiment of the present disclosure will be described below.

### 2. Method of Controlling Load of Water Electrolysis Stack

### 2.1. Method of Controlling Load of Water Electrolysis Stack According to First Embodiment

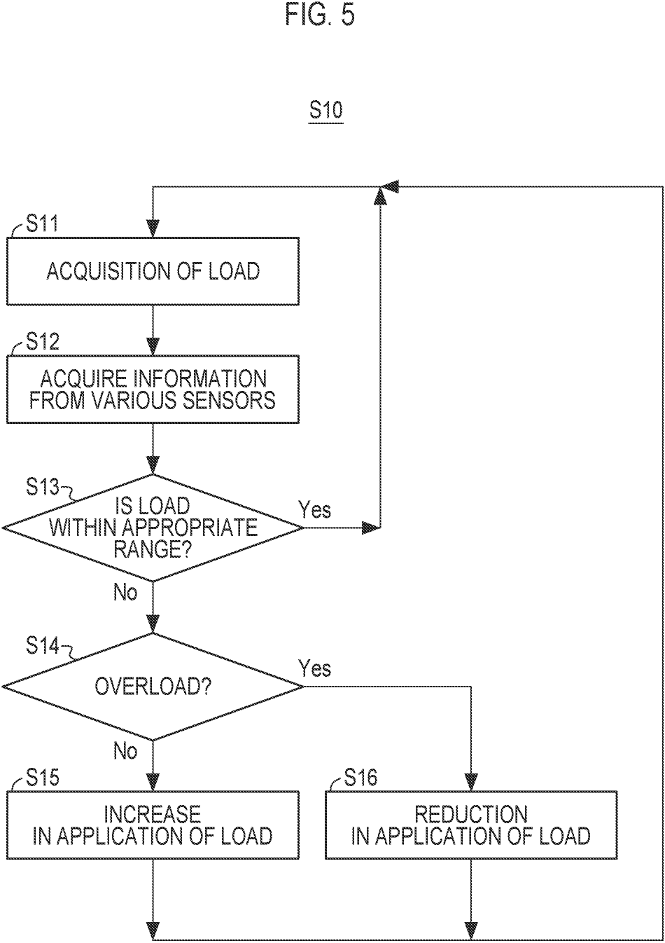

FIG. 5 shows a flow of a method of controlling the load of a water electrolysis stack S10 (hereinafter sometimes referred to as “load control S10”) according to a first embodiment. As can be seen from FIG. 5, the method of the load control S10 includes steps S11 to S16. The computer program stored in the controller 60 described above is constituted of specific instructions for the computer to execute the respective steps of the method of the load control S10.

### 2.1.1. Step S11

In step S11, the load applied to the water electrolysis cell 21 is acquired from the load cell 54.

### 2.1.2. Step S12

In step S12, the information is acquired from various sensors. Specifically, examples of the information include at least one selected from the temperature in the water electrolysis stack 20, the electrical resistance of the stacked body of the water electrolysis cells 21, and the flow rate of the supplied purified water.

### 2.1.3. Step S13

In step S13, the controller 60 determines whether the load detected in step S11 is in an appropriate range. In such a case, the values which are obtained in step S12 and the operating conditions are taken into consideration, and the controller 60 determines whether the load is within the range as compared with a preset load. If Yes in step S13, the load is appropriate, the process returns to step S11. If No in step S13, the load is inappropriate, the process proceeds to step S14.

### 2.1.4. Steps S14 to S16

In step S14, the controller 60 determines whether the load outside the appropriate range is an overload. If No, the process proceeds to step S15, and the controller 60 increases the application of the load by operating the servomotor 55a. If Yes, the process proceeds to step S16, and the controller 60 reduces the application of the load by operating the servomotor 55a. Then, the process returns to step S11.

### 2.2. Method of Controlling Load of Water Electrolysis Stack According to Second

### EMBODIMENT

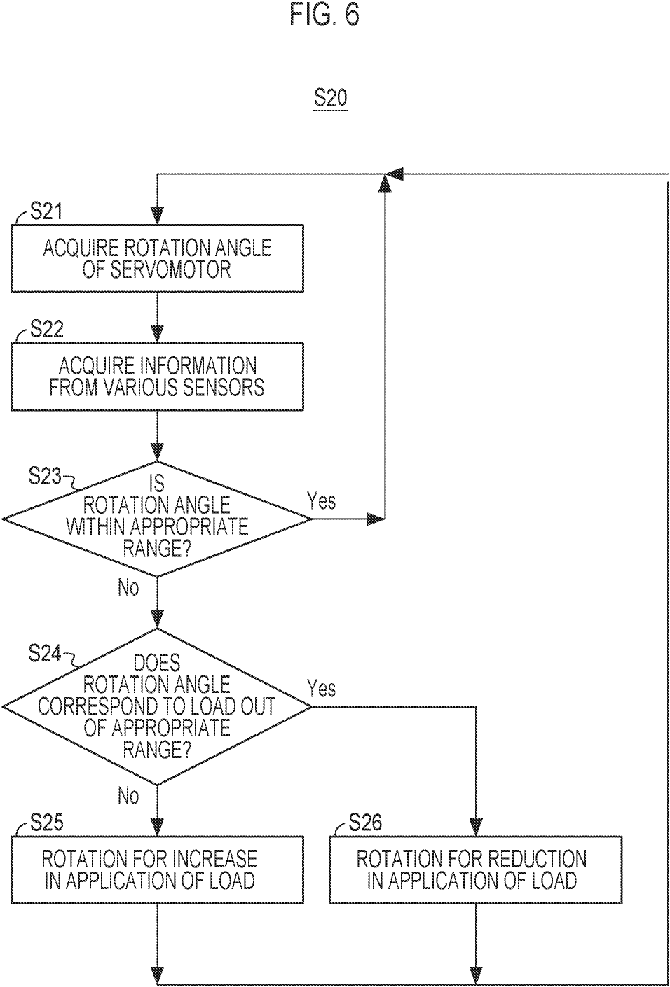

FIG. 6 shows a flow of a method of controlling the load of the water electrolysis stack S20 (hereinafter sometimes referred to as “load control S20”) according to a second embodiment. As can be seen from FIG. 6, the method of the load control S20 includes Steps S21 to S26. The computer program stored in the controller 60 described above is constituted of specific instructions for the computer to execute the respective steps of the method of the load control S20.

### 2.2.1. Step S21

In step S21, a current rotation angle of the servomotor 55a is acquired.

### 2.2.2. Step S22

In step S22, the information is acquired from various sensors. Specifically, examples of the information include at least one selected from the temperature in the water electrolysis stack 20, the electrical resistance of the stacked body of the water electrolysis cells 21, and the flow rate of the supplied purified water.

### 2.2.3. Step S23

In step S23, the controller 60 determines whether the rotation angle of the servomotor which is obtained in step S21 is within an appropriate range. In such a case, the values which are obtained in step S22 and the operating conditions are taken into consideration, and the controller 60 determines whether the load at the rotation angle is within an appropriate range as compared with the relationship between the preset rotation angle and the load. If Yes in step S23, the load is appropriate, the process returns to step S21. If No in step S23, the load is inappropriate, the process proceeds to step S24.

### 2.2.4. Steps S24 to S26

In step S24, the controller 60 determines whether the rotation angle is a rotation angle corresponding to the load outside the appropriate range. If No, the process proceeds to step S25, and the controller 60 increases the application of the load by rotating the servomotor 55a. If Yes, the process proceeds to step S26, and the controller 60 reduces the application of the load by rotating the servomotor 55a. Then, the process returns to step S21.

### 3. Effects and the Like

According to the embodiments of the present disclosure, the load of the water electrolysis stack can be appropriately maintained in the water electrolysis apparatus, and leaks and early deterioration can be suppressed. In particular, the load can be adjusted in accordance with changes in the conditions during operation of the water electrolysis apparatus. Therefore, the effect is enhanced. Further, by using the controller, such control can be automatically performed by a computer program.

In addition to normal hydrogen production using the water electrolysis cells, it is also possible to perform hydrogen production by periodically performing load control through the above-mentioned load control of the water electrolysis stack.

What is claimed is:

1. A method of controlling a load of a water electrolysis stack in which a plurality of water electrolysis cells including an anode disposed on one side and a cathode disposed on an other side with a solid polyelectrolyte film interposed are stacked and housed, the method comprising:
determining an appropriate load based on a condition of an inside of the water electrolysis stack obtained from at least one of a temperature of the inside of the water electrolysis stack, an electrical resistance, or a water flow rate; and
changing application of the load on the water electrolysis stack such that the load is the appropriate load.

2. A method of producing hydrogen, the method comprising:
performing normal hydrogen production by the water electrolysis cells; and
performing hydrogen production by periodically performing load control by the method of controlling the load of the water electrolysis stack according to claim 1.

3. A water electrolysis apparatus including a water electrolysis stack in which a plurality of water electrolysis cells including an anode disposed on one side and a cathode disposed on an other side with a solid polyelectrolyte film interposed are stacked and housed, the water electrolysis apparatus comprising:
a pressurizer that is provided in the water electrolysis stack and is configured to apply a load to the water electrolysis cells by pressing the water electrolysis stack;
at least one sensor of a sensor that is configured to measure a temperature of an inside of the water electrolysis stack, a sensor that is configured to measure an electrical resistance, or a sensor that is configured to measure a water flow rate; and
a controller that is configured to receive signals from the pressurizer and the at least one sensor and is connected to transmit a signal to the pressurizer,
wherein the controller is configured to determine an appropriate load based on a condition of the inside of the water electrolysis stack obtained from at least one of the temperature of the inside of the water electrolysis stack, the electrical resistance, or the water flow rate measured by the at least one sensor, and instruct the pressurizer to change application of the load on the water electrolysis stack such that the load is the appropriate load.

4. A controller configured to control a load of a water electrolysis stack in which a plurality of water electrolysis cells including an anode disposed on one side and a cathode disposed on an other side with a solid polyelectrolyte film interposed are stacked and housed, the controller comprising a processor, wherein the processor is configured to:
determine an appropriate load based on a condition of an inside of the water electrolysis stack obtained from at least one of a temperature of the inside of the water electrolysis stack, an electrical resistance, or a water flow rate; and
change application of the load on the water electrolysis stack such that the load is the appropriate load.
